(19) United States
(12) Patent Application Publication
(10) Pub. No.: US 2012/0233604 A1
(43) Pub. Date: Sep. 13, 2012

(54) METHOD FOR CONCURRENTLY SUPPORTING NEW AND LEGACY THIRD PARTY BOOT-SETS IN AN ARRAY

(76) Inventors: Mahmoud K. Jibbe, Wichita, KS (US); Chandan A. Marathe, Bangalore (IN)

(21) Appl. No.: 13/042,697

(22) Filed: Mar. 8, 2011

(51) Int. Cl. G06F 9/44

(52) U.S. Cl. 717/168

(57) ABSTRACT

A method for updating software in a controller, comprising the steps of (A) comparing a current boot-set to a host boot-set to determine if a new boot-set is needed, (B) determining if one or more specifications of a new boot-set are met and (C) updating the controller to the new boot-set. An agent may control the controller during the updating to allow the controller to process data requests during the updating.

### FIELD OF THE INVENTION

The present invention relates to storage systems generally and, more particularly, to a method and/or apparatus for concurrently supporting new and legacy third party boot-sets in a storage array.

### BACKGROUND OF THE INVENTION

In conventional Redundant Array of Independent Disks (RAID) approaches, a situation can occur where a newer fail-over driver, host bus adapter driver, host context agent, host software, and host automation agent are running. The newer modules demand a different controller firmware to operate. Conventional approaches download newer controller firmware to support the corresponding host modules, such as fail-over driver, host context agent, and host software. With potentially huge amounts of data being written, the download process can cause downtime and overhead on the system.

If a switch to the newer module from a legacy module is needed, the dependencies of the host component modules will not be known to a customer using conventional approaches. If a switch is made to a different controller firmware, the system can have un-supported host component modules.

If a newer host module is running, but older controller firmware is in place, the conventional approach is to download the newer controller firmware and reset the controller. The array will not be available during the reset, which may be a period of up to 2 to 5 minutes. In such an approach, the host software will not point out the differences between host component modules and the controller firmware. Even if the older controller firmware is running with newer host component modules (or vice versa), a customer would not be aware of the out of date component unless a scan of the SAN components is made.

Conventional agents running on a RAID Controller do not keep track of the dependencies of the host component modules with the controller firmware. A customer will not know the dependencies, unless the customer scans for Storage Area Network (SAN) components periodically.

It would be desirable to have a dedicated agent running on a RAID Controller which talks to the host and retrieves information about the host component modules and/or updates the mapping tables for each boot-set residing on the RAID Controllers.

### SUMMARY OF THE INVENTION

The present invention concerns a method for updating software in a controller, comprising the steps of (A) comparing a current boot-set to a host boot-set to determine if a new boot-set is needed, (B) determining if one or more specifications of a new boot-set are met and (C) updating the controller to the new boot-set. An agent may control the controller during the updating to allow the controller to process data requests during the updating.

The objects, features and advantages of the present invention include providing a RAID controller that may (i) run with a boot-set of legacy drivers, host adapters, and/or switches, (ii) provide an alternate boot-set supporting new versions of various modules, (iii) have multiple active boot-sets of the same controller firmware (e.g., if one firmware crashes, the array may be brought up by just flipping over between the boot-sets), (iv) allow an upgrade to a newer version of firmware supporting the same host component modules as that of the previous firmware, then flip between the boot-sets to have the new firmware running, (v) notify an administrator to flip to the newer boot-set instead of downloading the newer one if the host component modules are new, but controller firmware is legacy and/or (vi) indicate to an administrator if the host software and/or legacy host components are running and/or provide an option to move on to the newer controller firmware.

### BRIEF DESCRIPTION OF THE DRAWINGS

These and other objects, features and advantages of the present invention will be apparent from the following detailed description and the appended claims and drawings in which:

FIG. 1 is a block diagram of a storage system in accordance with the present invention;

FIG. 2 is a diagram illustrating details of a host and said controller; and

FIG. 3 is a flow diagram of the present invention.

### DETAILED DESCRIPTION OF THE PREFERRED EMBODIMENTS

In a Network Attached Storage (NAS) and Storage Area Network (SAN), Redundant Array of Independent Disks (RAID) controllers will normally have a single active firmware. Such controller firmware controls the product features, functionalities and/or third party vendor components (e.g., HBAs, HBA adapter drivers, fail-over drivers, switches/firmware, routers, etc.). In general, RAID controller firmware may be considered the main block of a SAN, similar to the Operating System of a server. Controller firmware may also handle activities such as routing input/outputs to backend disks through various layers. Controller firmware may also manage the fail-over of the resources and failing back of the resources. Fail-over may refer to a process used to provide redundancy when one or more components are not available. Fail-over may occur due to a component failure, a reboot after new software is loaded, or other scenarios. The present invention may increase system availability by reducing the number of components which are unavailable. In one example, the system availability may be increased by an order of magnitude (e.g., from 99.9% to 99.99%).

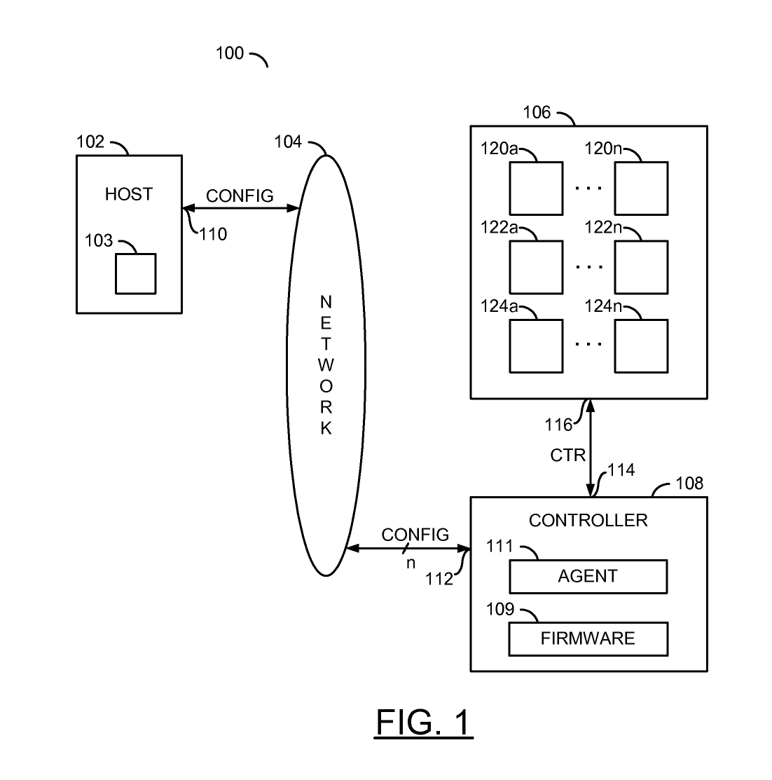

Referring to FIG. 1, a block diagram of a system 100 is shown illustrating a context of the present invention. The system 100 generally comprises a block (or circuit) 102, a network 104, a block (or circuit) 106 and a block (or circuit) 108. The circuit 102 may be implemented as a server host computer. The computer 102 may include a program 103. The program 103 may be considered a host program. The host 102 may be implemented as one or more computers in a host/client configuration. The circuit 106 may be implemented as a number of storage devices (e.g., a drive array). The circuit 108 may be implemented as a controller. In one example, the circuit 108 may be a RAID controller. The circuit 108 may include a block (or module, or circuit) 109 and a block (or module, or circuit) 111. The block 109 may be implemented as firmware that may control the controller 108. The block 111 may be implemented as an agent. The agent 111 may control the controller 108 if the firmware 109 is not available. The host 102 may have an input/output 110 that may present a configuration file (e.g., CONFIG). The file CONFIG may be sent through the network 104 to an input/output 112 of the controller 108. The controller 108 may have an input/output 114 that may present a signal (e.g., CTR) to an input/output 116 of the storage array 106.

The storage array 106 may have a number of storage devices (e.g., drives or volumes) 120a-120n, a number of storage devices (e.g., drives or volumes) 122a-122n and a number of storage devices (e.g., drives or volumes) 124a-124n. In one example, each of the storage devices 120a-120, 122a-122n, and 124a-124n may be implemented as a single drive, multiple drives, and/or one or more drive enclosures. In another example, each of the storage devices 120a-120, 122a-122n, and 124a-124n may be implemented as one or more non-volatile memory devices and non-volatile memory based storage devices (e.g., flash memory, flash-based solid state devices, etc.).

In one example, the host 103 may sequence the input parameters and start processing in the following sequence: (i) perform syntax check for the input file and generate an error if not met, (ii) perform physical hardware configuration versus requirements match analysis, (iii) generate the script with symbol commands, (iv) send one or more symbol commands via a file (e.g., Symbols.jar) to the storage array, (v) verify the configuration for correctness of volume configuration, mapping and attributes and/or (vi) save the configuration with a name. One or more of such processing steps may be implemented.

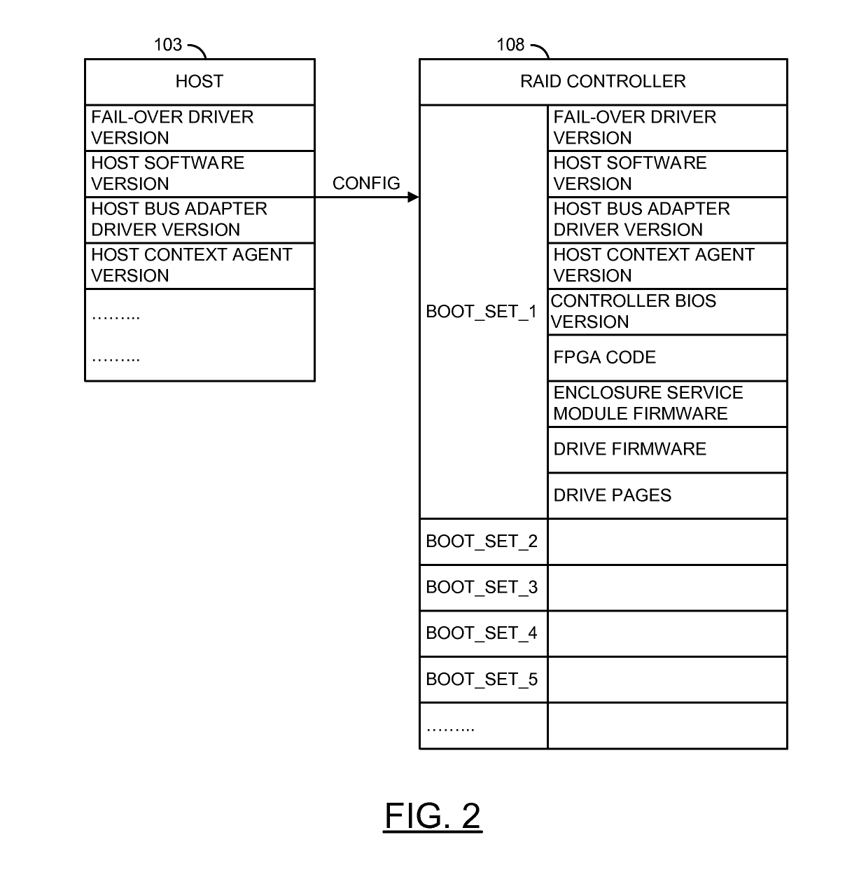

Referring to FIG. 2, a more detailed diagram of the host 103 and the controller 108 are shown. The system 100 may provide multiple boot-sets and/or mapping tables for each boot-set. Each boot-set may be implemented on a separate flash memory. For example, the controller 108 may implement a first boot-set (e.g., BOOT_SET_1) on a first flash memory, a second boot-set (e.g., BOOT_SET_2) on a second flash memory and an nth (e.g., where n is an integer greater than 1) boot-set (e.g., BOOT_SET_N) on an nth flash memory, depending on the design criteria of a particular implementation. The particular memory configuration(s) may be implemented depending on the design criteria of a particular implementation. For example, two boot-sets may be implemented on a single flash memory. In another example, n boot-sets may be implemented on a single flash memory. The mapping table for each boot-set normally includes the entries representing parameters such as the host adapter driver version, fail-over driver version and/or host context agent as shown by the following table:

TABLE 1

| | | | | Host |
|---|---|---|---|---|
| | Fail-over | Host Adapter | Host | Context |
| | Driver | Driver | Software | Agent |
| Boot-Set | Version | Version | Version | Version |
| X | X · Y · Z | Y | Z | A |
| X + 1 | X + 1 · Y + 1 · Z + 1 | Y + 1 | Z + 1 | A + 1 |
| X + N | X + N · Y + N · Z + N | Y + N | Z + N | A + N |

As shown in TABLE 1, each boot-set corresponds to a particular fail-over driver version, host adapter driver version, host software version and/or host context agent version. The agent 111 may run on the controller 108. The agent 111 may check whether the host component module 102 matches the value in the mapping table for a particular boot-set. The agent 111 may be implemented as a software program configured to run the controller 108 in a mode that does not need the firmware 109 to be active. If there is a mismatch between the controller firmware 109 and the host component module 102, and if the end-user is forced to switch (or flip) to a new boot-set, then the controller 108 would generally lock down. In a lock down state, the agent 111 may be used to run the controller 108.

In general, the controller 108 may be implemented as two or more controllers for redundancy. While the first controller is down, the second controller may overtake all the resources. The second controller may also serve the requests belonging to the first controller until the second controller becomes available. The controller 108 may support multiple boot-sets (e.g., BOOT_SET_1-BOOT_SET_N). Each boot-set may have a particular controller firmware 109. Each boot-set may support different third party component software versions. The third party software versions may be specified in a statement of work (SOW) or other specification. Each boot-set may include (i) a fail-over driver version, (ii) a host software version, (iii) a host bus adaptor driver version, (iv) a host context agent version, (v) a controller BIOS version, (vi) Field-programmable Gate Array (FPGA) code, (vii) enclosure service module firmware, (viii) drive firmware and/or (ix) drive pages.

In one example, a first boot-set (e.g., BOOT_SET_1) with a controller firmware (e.g., firmware 109) may support a first fail-over driver version (e.g., Y.0) and a second fail-over driver version (e.g., Y.1). The operating system may support a first version (e.g., Version 1.0) and a second version (e.g., Version 1.1). A second boot-set (e.g., BOOT_SET_2) with a controller firmware may support a third support fail-over driver version (e.g., Y.2) and a fourth fail-over driver version (e.g., Y.3). The operating system may support a third version (e.g., Version 1.2) and a fourth version (e.g., Version 1.3). Such boot-sets generally operate independently of each other. In the case where the controller 108 has more than one processor (e.g., a dual or quad processor), the controller firmware 109 may have multiple boot-sets per processor.

The agent 111 may be implemented on the controller 108 and dedicated to running the controller 108 when the firmware 109 is not available. In one example implementation, the agent 111 may be running on the controller 108 to allow the controller 108 to communicate with the host 103. The agent 111 may control the controller 108 while updating the controller 108 to a new boot-set. The agent 111 may allow the controller 108 to process data requests during the updating. The agent 111 may be implemented on the same integrated circuit/or chip (or a different integrated circuit/or chip) as the firmware 109. The agent 111 may allow the controller 108 to talk to the host 103 without interaction from the firmware 109. The agent 111 normally fetches the version identification of host component modules and compares the versions with the mapping table pertaining to a particular boot-set (e.g., BOOT_SET_1, BOOT_SET_2, etc.). If there is a mismatch, an administrator may receive a report regarding changes that may need to be incorporated. The administrator may be warned through a number of media (e.g., an e-mail, an indication through the host software, an event log, etc.).

An end-user may be directed with one or more event logs. Consider a scenario where a customer is running with legacy modules. If the customer wants to upgrade to the firmware 109, then the agent 111 will talk to the host 103. The customer will receive a notification. The notification may be in accordance with a number of parameters.

The customer may be notified to upgrade the host component modules to a version used by the newer boot-set. The newer host component module versions may have been fetched by the mapping tables pertaining to the corresponding boot-set. The customer may then start upgrading to the newer components. As soon as the upgrade is complete, the agent 111 normally knows that the host 103 is up-to-date and is ready to change over to the boot-set. The corresponding controller firmware 109 may be activated by a reset. The agent 111 may allow the controller 108 to process data requests during the change over to the boot-set. The data requests may comprise requests to read and/or write data to one or more of the storage devices 120a-120, 122a-122n, and 124a-124n.

If the host 103 comprises one or more components that do not need an upgrade, and the host 103 supports the newer boot-set the customer is willing to switch to, then the notification on the host 103 (e.g., through software, a message, etc.) will generally show a “good to go” status. The boot-set will then flip in response to a reset to the controller 108 and become active. The agent 111 may control the controller 108 during the boot-set flip. The system 100 may stay available to a user during the reset.

The end-user may be notified in a number of ways. When a customer would like to upgrade to a new boot-set, the agent 111 running on the controller 108 may talk to the host 103 and compare the host component 102 versions with the mapping table. If the versions match (or do not match), a notification will be sent to that administrator. This notification may include one or more of the following (i) an event log on the host software, (ii) an email to the administrator and/or (iii) a text message to the administrator.

Boot-set information may reside in the persistent setup-database. In a SAN/NAS environment, the configuration information will generally be saved on backend hard-disks using various processes. Additional information may be added in setup-data stored on the backend disks.

Meta data may be stored on the host 103. The meta data may include the total number of boot-set support, the total number of boot-sets present on the controller 108 and/or the size of the controller firmware 109 pertaining to each boot-set. The meta data may also include the current active boot-set, the controller firmware 109 version and/or the mapping table for each boot-set and supported host component modules.

A setup database may be stored on the backend disks. The following TABLE 2 shows a typical structure of the persistent setup-data on the backend disks. The setup-data may be stored at the beginning or the end of the disk depending on the design criteria of a particular implementation.

TABLE 2

| | | | | |
|---|---|---|---|---|
| | | | | Remaining space |
| | Second | Third | Boot-set, Host | of the setup-data |
| Header | Block | Block | component Meta Data | region |

<-----------Structure of the setup-data on the backend disk---------->

The boot-set information and/or the mapping tables may be stored in the structure shown in TABLE 2. These values may be modified when (i) switching to a new boot-set, (ii) upgrading the host-component modules and/or (iii) replacing a boot-set with new controller firmware.

A user may flip between the boot-sets. The user may choose a manual or an automatic mode to flip between boot-sets. If the host 103 does not satisfy the requirements for a particular boot-set, then an administrator may be notified. As soon as the host components are upgraded, the boot-set may be automatically (or manually) flipped by the user depending on the design criteria of a particular implementation. The agent 111 may allow the controller 108 to process data requests to one or more of the storage devices 120a-120, 122a-122n, and 124a-124n while flipping between boot-sets. A user may switch from a legacy module to a newer firmware version instead of switching between boot-sets. If the host 103 supports the newer boot-set, then the boot-set may be automatically or manually flipped. The system 100 may stay available to the user while updating the boot-set.

The agent 111 may run on the controller 108 to allow communication between the host 103 and the controller 108. The agent 111 is generally responsible for the communication between the host 103 and the controller 108. The agent 111 may communicate to the host 103 to acquire the host component 102 version and compare the host component 102 version with the mapping table. If the host component 102 version matches the boot-set entries, then the boot-set may be flipped by a reset. The host 103 may communicate with the controller 108 by providing the structure of the components and the component versions.

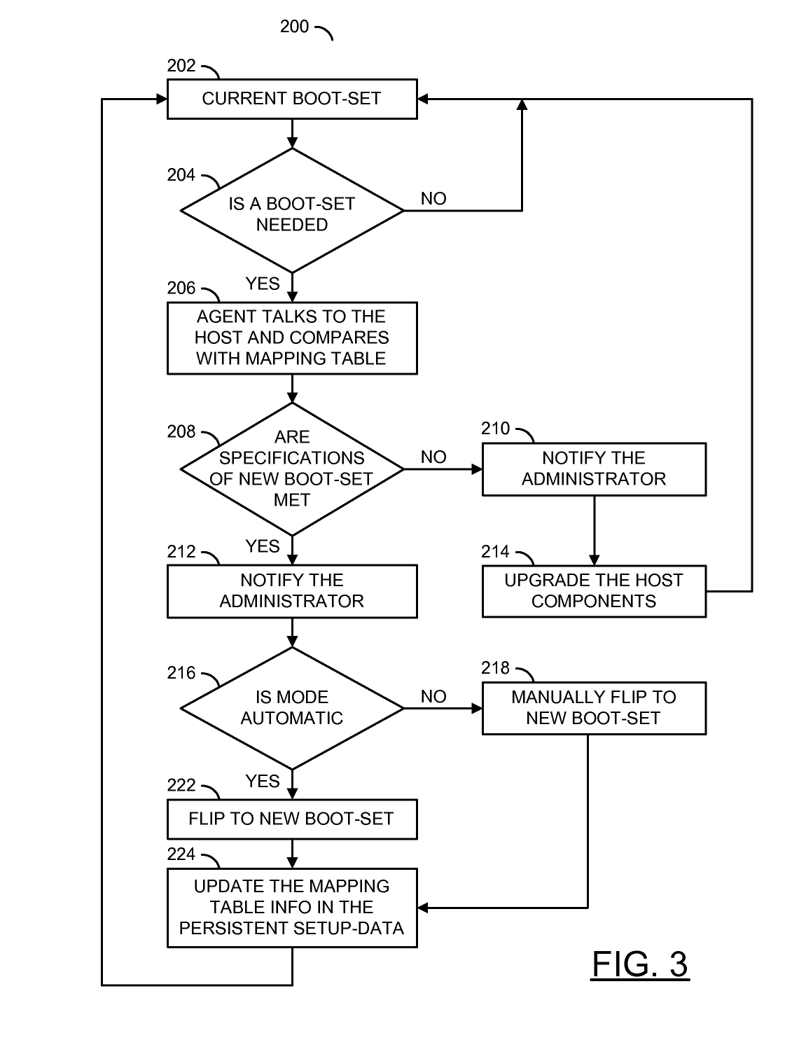

Referring to FIG. 3, a diagram of a process {or method) 200 is shown in accordance with the present invention. The process 200 generally comprises a step (or state) 202, a decision step (or state) 204, a step (or state) 206, a decision step (or state) 208, a step (or state) 210, a step (or state) 212, a step (or state) 214, a decision step (or state) 216, a step (or state) 218, a step (or state) 222, and a step (or state) 224. The state 202 may represent a current boot-set. The decision state 204 may determine if the system needs to flip to a new boot-set. If so, the method 200 moves to the state 206. If not, the method 200 moves back to the state 202. The state 206 may determine if the agent 111 talks to the host 103 and compares with the mapping table. Next, the decision state 208 may determine whether the system 200 meets the specifications of a new boot-set. If not, the method 200 moves to the state 210. If so, the method 200 moves to the state 212. In the state 210, a notification to the administrator may be sent. Next, the method 200 moves to the state 214. In the state 214, an upgrade of the host components may be formed. Next, the method 200 moves back to the state 202.

If the state 208 determines that the specifications of a new boot-set are met, then the method 200 moves to the state 212. In the state 212, the method 200 notifies the administrator. Next, the decision state 216 determines if a mode is automatic. If not, the method 200 moves to the state 218. In the state 218, a user may manually flip to a new boot-set. If the state 216 determines that the move is automatic, then the method 200 may move to the state 222 and automatically flip to a new boot-set. Next, the state 224 updates the mapping table onto the persistent set-up data.

Multiple flash memories may be used to store multiple controller firmware on the controller 108, based on the design criteria of a particular implementation. An agent 111 may run on the controller 108 to allow the controller 108 to talk to the host 103. Software code may be used incorporate changes to store the boot-set and the host component mapping table in the setup database. Software code may also be used to provide notifications to administrators of the host software.

The method 200 maybe implemented in SAN/NAS environment. Up-to-date SAN components, data availability and/or data reliability may be important features of an SAN/NAS environment. SAN/NAS components generally need to operate with the latest host software version, fail-over driver versions and/or host bus adapter driver versions with respect to the controller firmware 109 version. Before using the components, a customer may scan all the SAN/NAS equipment to verify whether the components comprise the latest (e.g., most up to date) driver versions. If the components do not comprise the latest drivers, the customer may manually update the driver versions. If the driver versions are up-to-date and the controller firmware 109 is an older version, then the customer may manually switch to a newer version of the controller firmware 109.

In the present invention, if the SAN/NAS components are up-to-date, and the controller firmware 109 comprises an old version, then the boot-set may be automatically (or manually) flipped (e.g., switched to the newer version of the controller firmware 109). In the automatic mode, an administrator may be notified that the boot-set that needs an update to the firmware 109 will become activated. In the manual mode, the administrator may be notified that the controller firmware 109 is not compatible with the SAN/NAS components. The administrator may prompt the boot-set needing an updated version of the firmware 109. The administrator may also prompt that the boot-set that needs an update to the firmware 109 will become activated. The SAN/NAS components may then be updated by flipping to the appropriate boot-set. The proposed method may be implemented without incurring large costs when implemented in a SAN/NAS environment.

The functions performed by the diagram of FIG. 3 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. A method for updating software in a controller, comprising the steps of:
(A) comparing a current boot-set to a host boot-set to determine if a new boot-set is needed;
(B) determining if one or more specifications of a new boot-set are met; and
(C) updating said controller to said new boot-set, wherein an agent controls said controller during said updating to allow said controller to process data requests during said updating.

2. The method according to claim 1, wherein said controller is connected to a drive array.

3. The method according to claim 2, wherein said data requests comprise requests to read and write data to said drive array.

4. The method according to claim 1, wherein said controller comprises a Redundant Array of Independent Disks (RAID) controller.

5. The method according to claim 4, wherein said RAID controller is implemented in a Network Attached Storage (NAS).

6. The method according to claim 4, wherein said RAID controller is implemented in a Storage Area Network (SAN).

7. The method according to claim 1, wherein said agent comprises a dedicated agent configured to retrieve information about said host boot-set.

8. The method according to claim 7, wherein said dedicated agent is configured to update one or more mapping tables for each new boot-set residing on said controller.

9. The method according to claim 1, wherein said new boot-set and said host boot-set each contain multiple boot-sets with the same controller firmware.

10. The method according to claim 1, wherein a user initiates a manual charge to said new boot-set.

11. An apparatus comprising:
means for comparing a current boot-set to a host boot-set to determine if a new boot-set is needed;
means for determining if one or more specifications of a new boot-set are met; and
means for updating a controller to said new boot-set, wherein an agent controls said controller during said updating to allow said controller to process data requests during said updating.

12. An apparatus comprising:
a controller configured to control an operation of an array of storage devices; and
an agent configured to compare a current boot-set to a host boot-set to determine if a new boot-set is needed, wherein said agent (i) determines if one or more specifications of a new boot-set are met, (ii) updates said controller to said new boot-set, and (iii) controls said controller during said updating to allow said controller to process data requests during said updating.

13. The apparatus according to claim 12, wherein said controller is connected to a drive array.

14. An apparatus according to claim 12, wherein said agent comprises a software agent.

15. An apparatus according to claim 12, wherein said controller comprises a Redundant Array of Independent Disks (RAID) controller.

16. An apparatus according to claim 15, wherein said RAID controller is implemented in a Network Attached Storage (NAS).

17. An apparatus according to claim 15, wherein said RAID controller is implemented in a Storage Area Network (SAN).

18. The apparatus according to claim 12, wherein said boot-set comprises one or more of (i) a fail-over driver version, (ii) a host software version, (iii) a host bus adaptor driver version, and (iv) a host context agent version.

19. The apparatus according to claim 12, wherein said agent comprises computer executable instructions that when executed provide said comparison and control.

20. The apparatus according to claim 12, wherein said apparatus is implemented as one or more integrated circuits.
